(19) United States
(12) Patent Application Publication
(10) Pub. No.: US 2013/0284778 A1
(43) Pub. Date: Oct. 31, 2013

(54) SECURING MECHANISM

(71) Applicants: Peter Douglas Hubbard, Christchurch (NZ); Bruce John Robertson, Christchurch (NZ)

(72) Inventors: Peter Douglas Hubbard, Christchurch (NZ); Bruce John Robertson, Christchurch (NZ)

(73) Assignee: HUBCO AUTOMOTIVE LIMITED, Wellington (NZ)

(21) Appl. No.: 13/702,989

(22) PCT Filed: Jun. 7, 2011
(86) PCT No.: PCT/NZ11/00099

§ 371 Date: Jul. 16, 2013

(30) Foreign Application Priority Data
Jun. 7, 2010 (NZ) 583778

(51) Int. Cl. B60R 9/048

(52) U.S. Cl. CPC B60R 9/048
USPC 224/282

(57) ABSTRACT

The invention relates to a roof box 1 for mounting to a vehicle. The roof box 1 includes a securing mechanism 10 that enables the top section 2 of the box 1 to be secured to the base section 3 of the box 1 via a single locking point and which urges the top section 2 from the base section 3 when the roof box 1 securing mechanism 10 is opened allowing the user access to lift the top section 2 open.

### RELATED APPLICATIONS

This application claims priority from New Zealand patent application number 583778 dated 7 Jun. 2010, the contents of which are incorporated herein by reference.

### TECHNICAL FIELD

The application relates to a securing mechanism. More specifically, the application relates to a securing mechanism used in a vehicle roof box, particularly but not exclusively, a roof box with a flush seam.

### BACKGROUND ART

Roof boxes are well known and commercialised worldwide. Roof boxes comprise a container mountable to a roof area of a vehicle and are adapted to store luggage, cargo and/or other objects (e.g. sporting equipment such as skis and snowboards). Typically, the roof box is made up of a bottom section for mounting to the roof area of a vehicle and a top section movable relative to the bottom section for opening and closing the roof box. Roof boxes may be preferable to an open roof rack accessory holder since they protect the items stored inside from exposure to adverse weather and environmental conditions. Roof boxes can also be locked closed thereby providing protection against theft and vandalism.

There are a wide range of different styles, features and prices available although roof boxes have become very standardised in design. In particular, typical design features common to many designs include central locking, double sided opening, quick fit attachment from inside the roof box, the ability to fit the box to a range of roof racks and various styling shapes.

One drawback of some roof box designs is that the locking and opening mechanism may require considerable effort on the part of the user to, for example, unclip at multiple points to release the top section. Alternatively, it may be necessary to unlock the box and then engage a separate opening button or lever in order to open the top section of the roof box. A further drawback, particularly of flush seam roof boxes is that there is no obvious point at which the user can gain leverage of the top section in order to lift this from the base section when opening the roof box. It is preferable to only have to unlock and open the top section of the box by as few steps as possible to save time, improve the design aesthetics, avoid the user having to reach hard to access areas on the roof of the vehicle and to urge apart the top section from the base section to allow the user access to the underside of the hinge in order to lift the top section away from the base section.

It is an object of the present invention to address the foregoing problems or at least to provide the public with a useful choice.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description that is given by way of example only.

### SUMMARY

The application broadly relates to a roof box with a securing mechanism that allows the user to unlock and open, or close and lock, the roof box at a single point. The mechanism also urges the top section from the base section to an open configuration when a user unlocks the box making it easier to open the roof box.

In a first embodiment there is provided a roof box including a base section mountable to a vehicle roof rack and a top section including at least one hinge wherein, the top section is movable relative to the base section for opening and closing the roof box, and wherein the roof box has a securing mechanism including:
a. at least one lock assembly that communicates with;
b. at least one hinge lifter;

and wherein, when the lock assembly or assemblies are actuated, the hinge lifter or lifters urge the top section from a closed or top secured to the base section configuration to an open or top section lifted relative to the base section configuration.

In a second embodiment, there is provided a roof box substantially as described above which has two hinges mounted along the hinged edge of the top section, two corresponding hinge receiving apertures in the base section, two hinge lifters, and one lock assembly.

In a third embodiment there is provided a method of releasably locking and unlocking a roof box top section to a base section by use of the roof box locking mechanism substantially as described above.

The above roof box securing mechanism provides a simple and efficient closure to a roof box. The design may be such that only a single key turn is required to activate and unlock multiple lock points. The design may also assist with opening of the box by partially lifting the top section from the base section on unlocking, allowing the user to be able to easily access the seam and lift open the top section. As may be appreciated, this is particularly useful in a flush seam roof box design where, unless a handle or other protrusion is added, there is no easy access to lift the top section. ‘Popping up’ of the top section caused by the locking mechanism allows the user to access under the seam and lift the top section of the box to a maximum opening position.

### BRIEF DESCRIPTION OF THE DRAWINGS

Further aspects of the present invention will become apparent from the following description that is given by way of example only and with reference to the accompanying drawings in which:

FIG. 1 illustrates an assembled perspective view from above of one embodiment of the roof box of the invention;

FIG. 2 illustrates a perspective view of the base section of the roof box with the top section removed;

FIG. 3 illustrates a perspective view of the base section of the roof box with the top section removed showing the lock assembly and link arms in further detail;

FIG. 4A illustrates a detail perspective view of the hinge and hinge lifter prior to the hinge engaging the hinge lifter corresponding to a roof box open configuration;

FIG. 4B illustrates a detail perspective view of the rear of the hinge receiver with the hinge latch removed in a roof box closed configuration;

FIG. 4C illustrates an elevation view of the rear of the hinge receiver with the hinge latch removed in a roof box closed configuration;

FIG. 4D illustrates a cross section perspective view of the hinge latch and lock rod when in a roof box closed configuration;

FIG. 5 illustrates a detail perspective view of the hinge and hinge lifter with the hinge receiver removed showing the hinge partly engaging the hinge latch toggle wedge corresponding to a roof box closing configuration;

FIG. 6 illustrates a detail perspective view of the hinge and hinge lifter with the hinge receiver removed showing the hinge fully engaged with the hinge latch toggle wedge corresponding to a roof box closed configuration;

FIG. 7 illustrates a detail elevation view of a lock assembly in a roof box open configuration; and

FIG. 8 illustrates a detail elevation view of a lock assembly in the roof box closed configuration.

### DETAILED DESCRIPTION

As noted above, the application broadly relates to a roof box with a securing mechanism that allows the user to unlock and open, or close and lock, the roof box at a single point. The mechanism also urges the top section from the base section when the box is unlocked making it easier to open the box.

For the purpose of this specification, the term ‘open configuration’ and grammatical variations thereof refers to the top section of the roof box being separated from the base section at least sufficient to allow a user to observe a gap on one side of the roof box seam between the roof box top section and base section.

The term ‘closed configuration’ and grammatical variations thereof refers to the roof box top section and base section abutting together about a seam between the top and base sections.

In a first embodiment there is provided a roof box including a base section mountable to a vehicle roof rack and a top section including at least one hinge wherein, the top section is movable relative to the base section for opening and closing the roof box, and wherein the roof box has a securing mechanism including:
a. at least one lock assembly that communicates with;
b. at least one hinge lifter;

and wherein, when the lock assembly or assemblies are actuated, the hinge lifter or lifters urge the top section from a closed or top secured to the base section configuration to an open or top section lifted relative to the base section configuration.

In a closed configuration, the securing mechanism may secure the top section to the base section.

Actuation of the lock assembly or assemblies may be communicated to the hinge lifter or lifters via movement of one or more link arms.

Rotational movement of the lock assembly may be converted to linear movement of the one or more link arms that actuate the hinge lifter or lifters.

In one embodiment, the lock assembly may include a lock housing incorporating:
a. a key barrel and corresponding removable key;
b. a cut out section in the housing;
c. a linkage between the link arm or arms and the lock housing; and

wherein at least one link arm includes a protrusion that engages the cut out when the roof box is open thereby preventing rotation of the key barrel and removal of the key when the roof box is in an open configuration; and

wherein the protrusion disengages the cut out when the roof box is closed allowing removal of the key once in a closed configuration.

As noted above, the key or keys rotating the key barrel actuate the roof box locking assembly to open the roof box and wherein, when the top section is opened, an interlock prevents removal of the key or keys from the locking assembly. The interlock is disengaged when the roof box top section is closed. This design may assist in preventing the user from inadvertently locking the key or keys inside the roof box.

Each hinge lifter may include a hinge receiver attached to the base portion of the roof box that receives a hinge attached to the top portion of the roof box and:
a. when in the closed configuration, the hinge is received and retained within the hinge receiver; and
b. when in the open configuration, the hinge leaves the hinge receiver.

The hinge receiver may include:
a. a hinge lifter including a wedge and corresponding cut out in a link arm that is linked to a lock rod; and
b. a hinge latch that contacts at one the hinge when inserted into the hinge receiver and at the opposing end contacts a toggle linked to the lock rod.

The hinge may strike the hinge lifter as the roof box is closed thereby actuating movement of the toggle via the hinge latch from a lock rod secured position to a lock rod released position and the hinge lifter wedge may also be forced from the cut out in the lock rod, both actions resulting in the lock rod moving laterally via a bias means thereby causing rotation of the lock assembly to a locked position via lateral movement of the link arm or arms.

When the fully closed configuration is reached, a wedge stop on the hinge latch may be received into a corresponding aperture in the hinge resulting in an audible click sound, the wedge stop on the hinge latch securing the hinge against the bias means of the hinge lifter.

On actuation of the lock assembly, the lock rod or rods may force the link arm in a lateral direction opposite to that on closing of the roof box causing the toggle to move away and allow the hinge latch wedge stop out of the hinge aperture thereby allowing the hinge lifter to force the hinge out of the receiver via a bias means and in doing so, the hinge lifter wedge disengages the cut out in the lock rod.

The hinge receiver or receivers may be mounted on a longitudinal side wall of the base section.

The top section may have two hinges mounted along the hinged edge, two corresponding hinge receivers in the base section and two link arms both of which communicate with one lock assembly all forming one securing mechanism. In this embodiment, the top section of the roof box may hinge from either side of the roof box base section. As may be appreciated, this configuration allows the user to open and close the top section from either side of the roof box. This may be useful as, when mounted to a vehicle, the roof box may be accessed from either side of the vehicle.

The lock assembly may be located along the base section side wall between the hinge lifter or lifters.

The top section of the roof box may hinge from either side of the roof box base section and wherein the top section includes at least one securing mechanism on either side of the roof box.

In one embodiment, the securing mechanism urges the top section from the base section by at least 5 mm along the non-hinged side of the roof box when opened from a closed configuration. In another embodiment, the mechanism may urge the top section 10 mm from the base section.

In another embodiment, the mechanism may urge the top section 15 mm from the base section. In another embodiment, the mechanism may urge the top section 20 mm from the base section. In another embodiment, the mechanism may urge the top section 25 mm from the base section. In another embodiment, the mechanism may urge the top section 30 mm from the base section. In the above embodiments, the extent to which the top section is urged from the base is the ‘open configuration’. As may be appreciated, the boot of many cars may be urged upwards on opening however this is completed at one central point (one lock and one lifting mechanism) as part of the lock assembly and not via a separate hinge lifter assembly as in the securing mechanism described herein. In addition, car boot lifters are only openable from one side and not multiple sides. The length and weight distribution of a roof box means that two or more hinge lifter assemblies may provide the best leverage. Multiple securing mechanisms also allow for dual sided opening.

Optionally, the securing mechanism may be housed within an enclosure and the only visible portions of the securing mechanism viewable from the exterior of the roof box when assembled is the lock chamber outer facing which receives the key. Optionally, the base section of the roof box may be at least partially double skinned having an outer base skin and an inner base skin fastened together. In this configuration, the securing mechanism may be housed between the two skin sections. Alternatively, if only a single layer is used to form the base section, the securing mechanism may be housed behind a mounting panel along part or all of the length of the base section side wall. A mounting panel like this may be advantageous in order to help stiffen the side walls of the roof box base section, particularly around hinge points.

To further clarify the hinge action, the following mechanical description is provided to illustrate one particular roof box embodiment. The hinge action is such that a hinge or hinges on the opening side of the roof box may move in and out of a housing (the hinge receiver or receivers) when the roof box top section is opened and closed. This configuration is useful in applications where hinges are located on either side of the roof box as the top section may be opened from either side. More specifically, when one side is opened, the hinge or hinges at the closed side of the roof box remain fixed in the hinge receiver or receivers while the hinge or hinges on the opposing opening side remain fixed to the top section and the hinge(s) lifts out of the hinge receiver(s) as the top section is opened. When the top section is closed, the hinge or hinges return back into the hinge receiver(s) and action the securing mechanism on the side of the roof box being closed. The top section of the roof box may then be opened from the opposing side reversing the above mechanics.

In a second embodiment, there is provided a roof box substantially as described above which has two hinges mounted along the hinged edge of the top section, two corresponding hinge receiving apertures in the base section, two hinge lifters, and one lock assembly.

In a third embodiment there is provided a method of releasably locking and unlocking a roof box top section to a base section by use of the roof box securing mechanism substantially as described above.

As noted above, the roof box securing mechanism provides a simple and efficient closure to a roof box. The design is such that only a single key turn is required to activate and unlock multiple securing mechanisms. The design also assists with opening of the box by partially lifting the top section from the base section on unlocking allowing the user to be able to easily access the seam and lift open the top section.

A specific a detailed example of the locking mechanism is now provided.

### WORKING EXAMPLES

The invention is now described with reference to a detailed description of an embodiment of the roof box of the present invention.

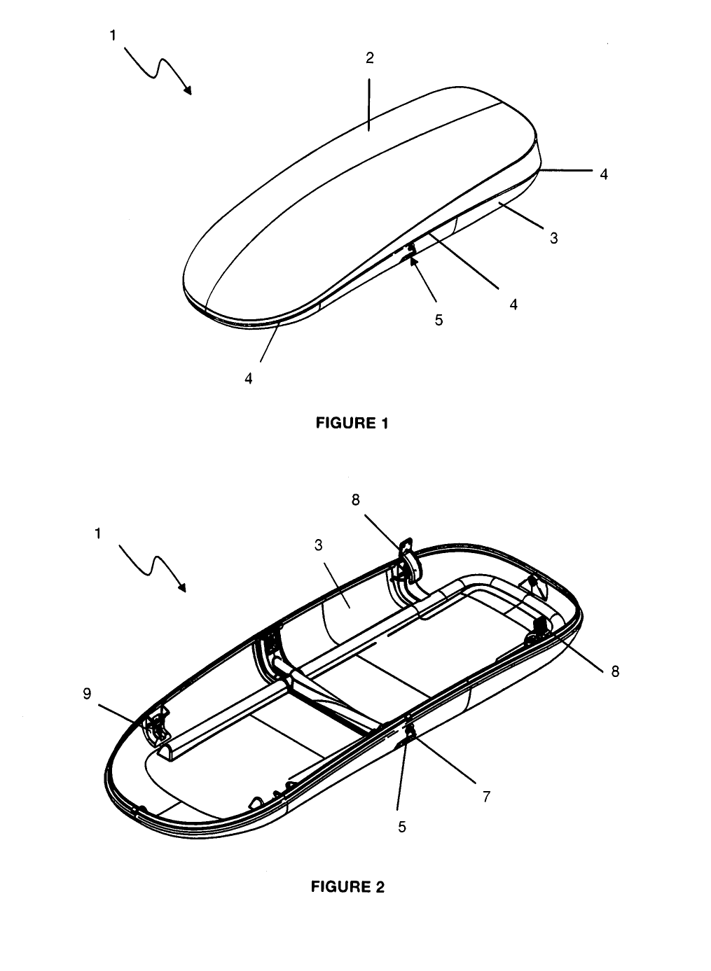

Referring to FIG. 1, the roof box, generally indicated by arrow 1, when closed has a styled, aesthetically appealing shape. The roof box 1 includes a top section 2 and a base section 3. The box 1 has a seam 4 between the top 2 and base 3 sections. The roof box 1 also includes a securing mechanism, the only exterior visible portion of which is the lock chamber and key as generally indicated by arrow 5.

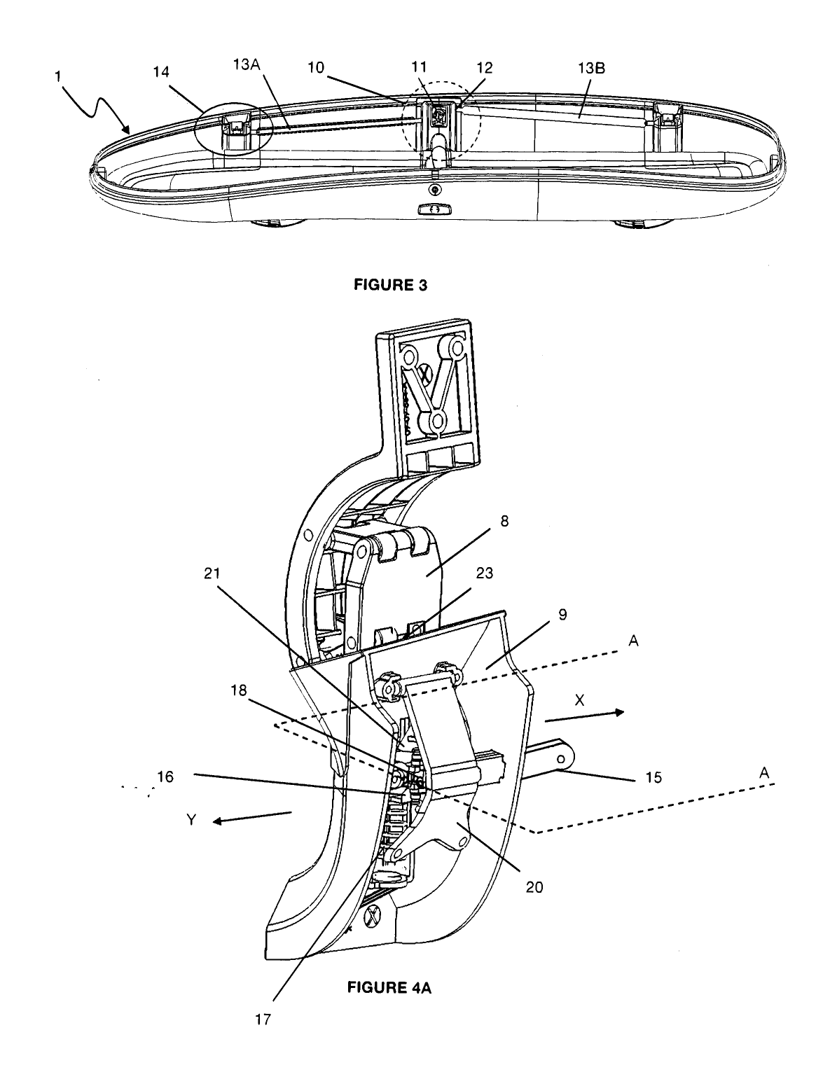

FIG. 2 illustrates the roof box 1 with the top section 2 removed. More of the internal details become visible. A key 7 is shown in the lock chamber 5. The roof box 1 has four hinges 8 (only two shown) attached to the top section 2 (not shown in FIG. 2) that, when the top section 2 is closed, engage and are received within hinge receivers 9 located around the longitudinal side walls of the base section 3 of the roof box 1. FIG. 2 illustrates two hinges 8 engaged within the base section 3 and opposing hinge receivers 9.

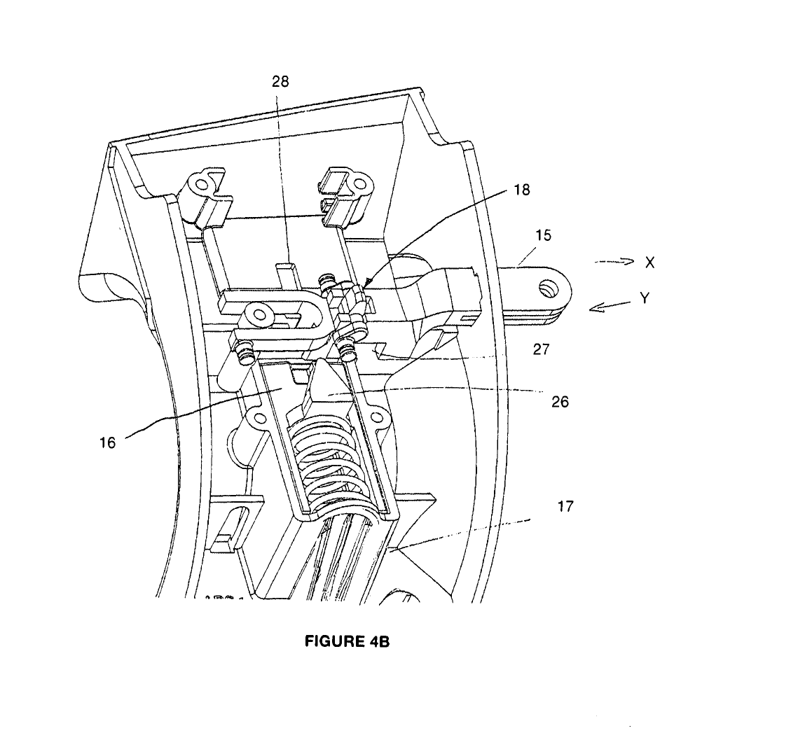

FIG. 3 illustrates the same embodiment as FIG. 2 but with the hinges 8 removed and the link arms 13A and 13B shown. The securing mechanism is then exposed which runs along the side longitudinal walls of the roof box 1. The lock assembly 10 includes a lock chamber 11 supported by a chamber mounting 12. The lock chamber 11 is rotationally linked to two link arms 13A and 13B. The link arm 13A, 13B endings attach to the upper and lower surface of the lock chamber 11 when in a roof box 1 closed configuration. When in a closed or locked position, the key 7 is in a vertical orientation when inserted into the lock chamber 5 for unlocking. When the key 7 is rotated 90° to the right in the embodiment shown, the link arms 13A,13B are urged outwards towards each hinge lifter 14 thereby actuating the hinge lifters 14 to lift the top section 2 from the base section 3 (i.e. lifting from a closed to an open configuration). The degree of lift may be sufficient to result in a gap of 5-30 mm between the non-hinged side of the seam between the base section 3 and the top section 2.

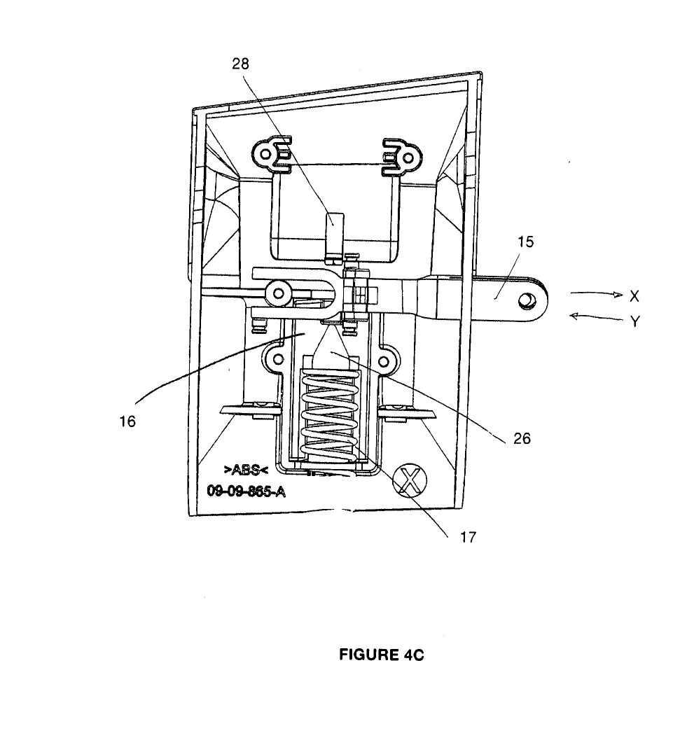

Referring to FIGS. 4 to 6, the hinge lifter assembly 14 is now described in more detail.

FIG. 4A illustrates the open configuration where the box 1 top section 2 (not shown) is open and the hinge 8 does not engage the hinge receiver 9. In this position the lock rod 15 which is attached to a link arm 13A (not shown) is fully urged in direction Y as shown in FIG. 4A. It is constrained in this position by the wedge 26 (on the hinge lifter 16) being fully entered into a cut out 27 in the lock rod 15. The hinge lifter 16 is urged upwards by the hinge lifter 14 spring 17. A toggle 18 located within the step on the hinge latch 20 and the wedge stop 21 fully protrudes through the aperture 28 in the receiver housing 9.

FIGS. 4B and 4C show the hinge receiver 9 in more detail. In these Figures, the box 1 is in a closed configuration and the hinge 8 is inserted into the hinge receiver 9. FIG. 4B shows the hinge lifter 16 spring 17 in a compressed position with the wedge 26 outside the cut out 27. The lock rod 15 has moved in direction X. FIG. 4C shows the same closed position as FIG. 4B but in an elevation view rather than a perspective view.

FIG. 4D shows a section view along line AA of FIG. 4A to further illustrate the relationship between the hinge latch 20 and the toggle 18. FIG. 4D shows a top 2 closed configuration with the toggle 18 standing upright against the hinge latch 20. As the box 1 top section 2 is closed, the toggle 18 rotates anticlockwise around axis 200 by movement of the lock rod 15 in direction X.

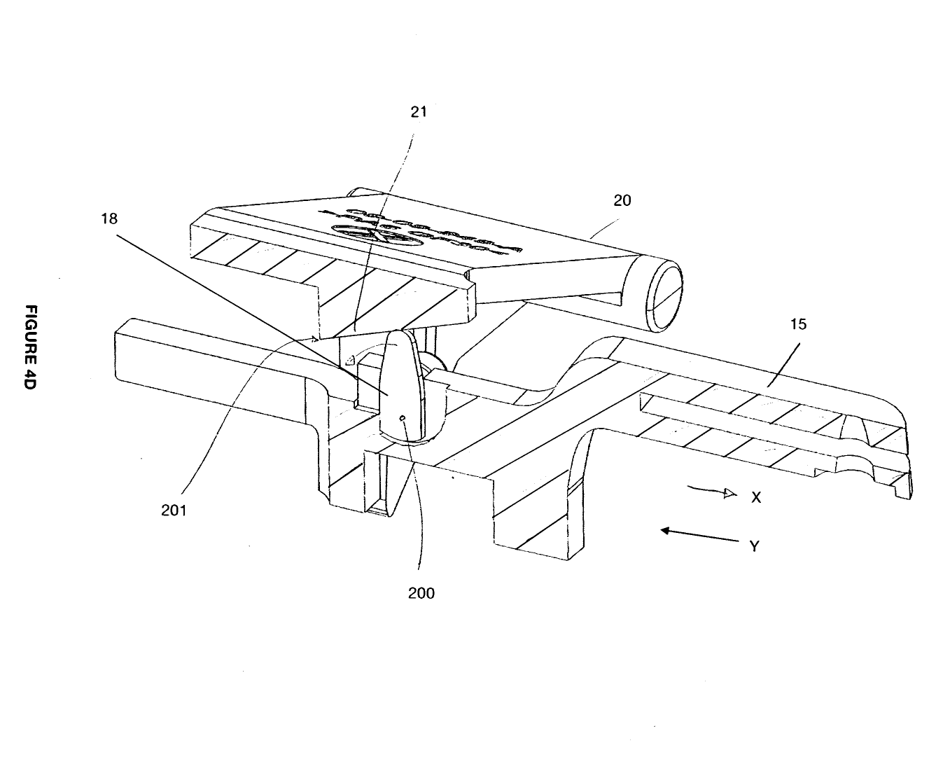

FIG. 5 illustrates the hinge 8 action when the when the hinge 8 begins to engage the hinge receiver 9 (housing removed for clarity). As the hinge 8 enters the hinge receiver 9 it makes contact with the wedge stop 21 forcing the hinge latch 20 away from the hinge 8. As the hinge 8 further enters the hinge receiver 9 it contacts the hinge lifter 16 forcing the lifter 16 in a downward direction against the pressure of lifter spring 17. Doing this releases the wedge 26 from the cut out 27. The latch arm 15 may now move to the right. In doing so, the toggle 18 contacts the step face of the hinge latch 20 and rotates away (direction Y in FIG. 4D) allowing the latch arm 15 to move fully in direction X. This in turn returns the key 7 in the securing mechanism to a vertical orientation.

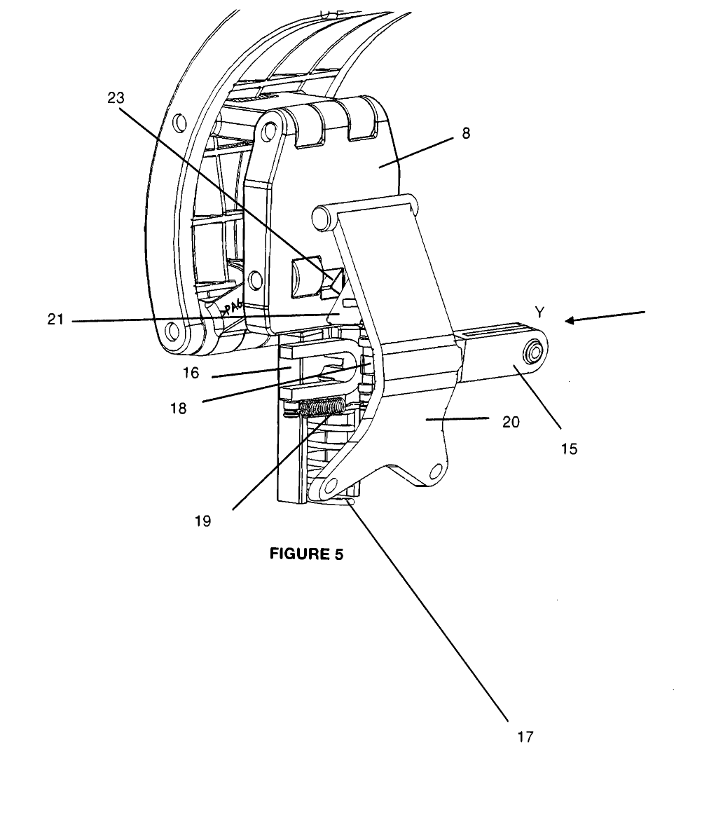

FIG. 6 Illustrates the closed configuration where roof box 1 top section 2 (not shown) is closed and the wedge stop 21 has fully entered the hinge aperture 23 in the hinge 8. This action produces an audible click noise giving the user a positive engagement sound.

The opening action of the hinge lifter 14 is thus summarised by:
a) Turning the key 7 in a clockwise direction which moves the link arm 13A and attached lock rod 15 in direction Y. This causes the toggle 18 to ride up the wedge stop 21 on the hinge latch 20 causing the wedge stop 21 to leave the hinge aperture 23.
b) Hinge 8 is then urged upward by the hinge lifter 16 having the effect of ‘popping’ the roof box 1 top section 2 open.
c) As the hinge lifter 16 moves upward, the lifter wedge 26 enters the cut out 27.
d) The wedge angle on the wedge stop 26 also acts to force the latch arm 15 in direction Y until the toggle 18 passes over step 201 of the hinge latch 20 wedge stop 26.

The hinge lifter assembly 14 is thus reset for the next top section 2 closure and the latch arm 15 restrained in the fully left or fully Y-direction position. This in turn holds the key 7 in the open position.

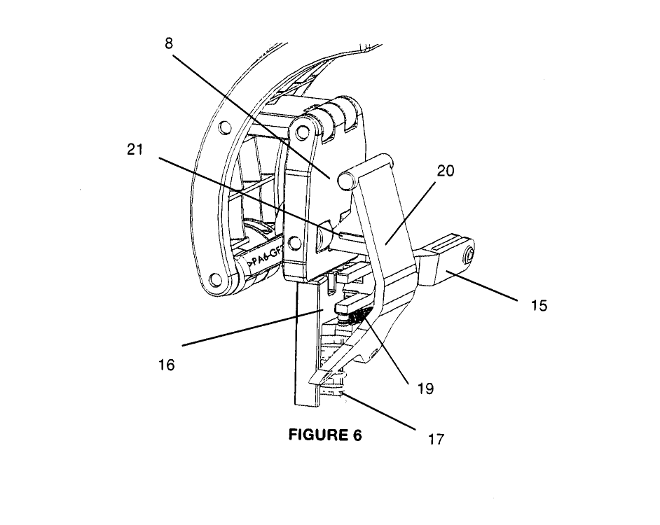

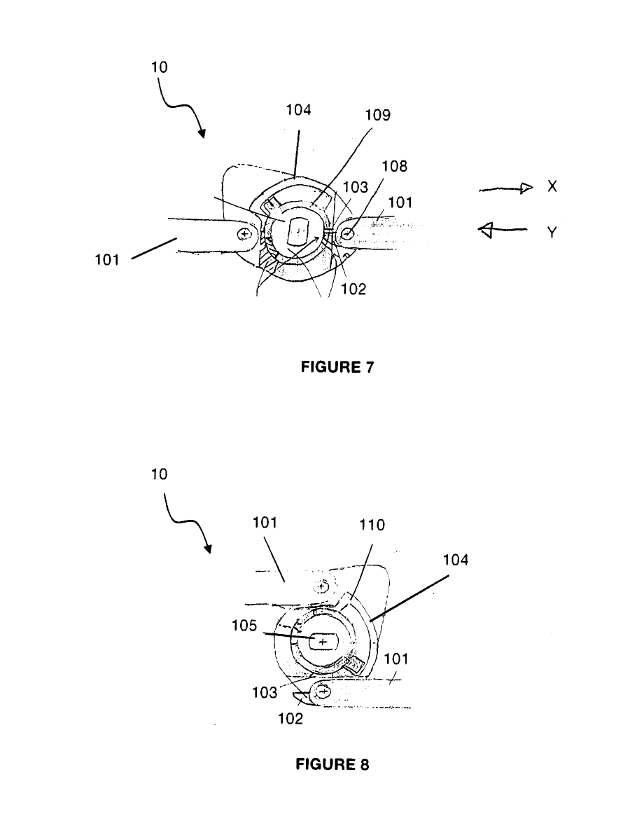

Referring to FIGS. 7 and 8, the locking assembly 10 is now described in further detail.

In FIG. 7, the key 7 has been turned in a clockwise direction approximately 90° from the vertical corresponding to an open configuration. The link arm 101 (equivalent to 13B) is urged in direction X by the action of wedge stop 26 (as described above) acting on the lock rod 15 which is connected to the other end of the link arm 101. This force acting through linkage 108 holds the lock cam 104 in its rotated anticlockwise position against a torsion spring (not shown) acting on the lock cam 104. In this position a beak 102 at the end of the link arm 101 has entered a cut-out in the lock housing 109. Any action to turn the lock housing 109 by means of the key barrel 105 (which mates with and drives lock housing 109) is thus prevented. The key .7 cannot be removed when in this position thereby preventing accidental locking of the key 7 in the roof box 1.

FIG. 8 shows the locking mechanism 10 in the top section 2 closed position. The lock rod 15 has now moved according to the action described above and in turn allowed the link arm 101 to move in direction Y. With the link arm 101 now free to move, the torsion spring (not shown) has rotated the lock cam 104 taking with it the lock housing 109 and the key barrel 105. The key 7 is therefore returned anti-clockwise to a vertical position or locked position and can be removed.

The opening action of the locking mechanism 10 is thus summarised by:
(a) The key 7 is turned in an anticlockwise direction.
(b) This rotates the key barrel 105 and the lock housing 109.
(c) By means of the step 110 on the lock housing 109, the action also drives the lock cam 104 in an anticlockwise direction causing the link arm 101 to move in direction X.
(d) This initiates the actions (described above) to open the top section 2 by moving the lock rod 15 in direction Y.

As should be appreciated from the above description, the securing mechanism 10 provided for the roof box 1 is simple to use and manufacture and allows the roof box 1 to be easily opened at only one point being the lock chamber 5. There is no need for the user to open a number of latches or attachment points in order to open the box 1. Further, the securing mechanism 10 engages automatically when the top of the roof box 1 is closed. A further advantage is that the securing mechanism 10 is discrete and housed within the walls of the roof box 1. Further, the mechanism 10 may be placed on both sides of the roof box 1 allowing opening from either side. A further aesthetic advantage of the securing mechanism 10 is that it produces a positive ‘click’ action on activation and, when unlocked, the action of the securing mechanism 10 ‘pops up’ the top section 2 of the roof box 1.

Aspects of the present invention have been described by way of example only and it should be appreciated that modifications and additions may be made thereto without departing from the scope of the claims herein.

1. A roof box including a base section mountable to a vehicle roof rack and a top section including at least one hinge wherein, the top section is movable relative to the base section for opening and closing the roof box, and wherein the roof box has a securing mechanism including:
a. at least one lock assembly that communicates with;
b. at least one hinge after;
and wherein, when the lock assembly or assemblies are actuated, the hinge lifter or lifters urge the top section from a closed or top secured to the base section configuration to an open or top section lifted relative to the base section configuration.

2. The roof box as claimed in claim 1 where, in a closed configuration, the securing mechanism secures the top section to the base section.

3. The roof box as claimed in claim 1 or claim 2 wherein actuation of the lock assembly or assemblies is communicated to the hinge lifter or lifters via movement of one or more link arms.

4. The roof box as claimed in claim 3 wherein rotational movement of the lock assembly is converted to linear movement of the one or more link arms that actuate the hinge lifter or lifters.

5. The roof box as claimed in claim 3 wherein the lock assembly includes a lock housing with:
a. a key barrel and corresponding removable key;
b. a cut out section in the housing; and
c. a linkage between the link arm or arms and the lock housing;
wherein at least one link arm includes a protrusion that engages the cut out when the roof box is open thereby preventing rotation of the key barrel and removal of the key when the roof box is an open configuration; and
wherein the protrusion disengages the cut out when the roof box is closed allowing removal of the key once in a closed configuration.

6. The roof box as claimed in claim 5 wherein each hinge lifter includes a hinge receiver attached to the base portion of the roof box that receive a hinge attached to the top portion of the roof box and:
a. when in the closed configuration, the hinge is received and retained within the hinge receiver; and
b. when in the open configuration, the hinge leaves the hinge receiver.

7. The roof box as claimed in claim 6 wherein the hinge receiver includes:
a. a hinge lifter including a wedge and corresponding cut out in a link arm that is linked to a lock rod;
b. a hinge latch that contacts at one the hinge when inserted into the hinge receiver and at the opposing end contacts a toggle linked to the lock rod.

8. The hinge receiver as claimed in claim 7 wherein the hinge strikes the hinge lifter as the roof box is closed thereby actuating movement of the toggle via the hinge latch from a lock rod secured position to a lock rod released position and the hinge lifter wedge is also forced from the cut out in the lock rod, both actions resulting in the lock rod moving laterally via a bias means thereby causing rotation of the lock assembly to a locked position via lateral movement of the link arm or arms.

9. The roof box as claimed in claim 8 wherein, when the fully closed configuration is reached, a wedge stop on the hinge latch is received into a corresponding aperture in the hinge resulting in an audible click sound, the wedge stop on the hinge latch securing the hinge against the bias means of the hinge lifter.

10. The hinge receiver as claimed in claim 9 wherein, on actuation of the lock assembly, the lock rod or rods force the link arm in a lateral direction opposite to that on closing of the roof box causing the toggle to move away and allow the hinge latch wedge stop out of the hinge aperture thereby allowing the hinge lifter to force the hinge out of the receiver via a bias means and in doing so, the hinge lifter wedge disengages the cut out in the lock rod.

11. The roof box as claimed in claim 6 wherein the hinge receiver or receivers are mounted on a longitudinal side wall of the base section.

12. The roof box as claimed in claim 6 wherein the top section has two hinges mounted along the hinged edge, two corresponding hinge receivers in the base section and two link arms both of which communicate with one lock assembly all forming one securing mechanism.

13. The roof box as claimed in claim 12 wherein the lock assembly is located along the base section side wall between the hinge lifter or lifters.

14. The roof box as claimed in claim 1 wherein the top section of the roof box hinges from either side of the roof box base section and wherein the top section includes at least one securing mechanism on either side of the roof box.

15. The roof box as claimed in claim 1 wherein the securing mechanism urges the top section from the base section by at least 5 mm along the non-hinged side of the roof box when opened from a closed configuration.
